(19) United States
(12) Patent Application Publication
(10) Pub. No.: US 2025/0052901 A1
(43) Pub. Date: Feb. 13, 2025

(54) DISTANCE MEASURING DEVICE AND SENSOR DEVICE

(71) Applicant: SONY SEMICONDUCTOR SOLUTIONS CORPORATION, KANAGAWA (JP)

(72) Inventors: KOHEI HARADA, KUMAMOTO (JP); MITSUHARU OHKI, KANAGAWA (JP)

(21) Appl. No.: 18/718,346

(22) PCT Filed: Nov. 24, 2022
(86) PCT No.: PCT/JP2022/043296

§ 371 Date: Jun. 10, 2024

(30) Foreign Application Priority Data
Dec. 20, 2021 (JP) 2021-205782

(51) Int. Cl. G01S 17/894; G01C 3/08; G01S 17/26

(52) U.S. Cl. CPC G01S 17/894; G01C 3/08; G01S 17/26

(57) ABSTRACT

A distance measuring device includes: a pixel array unit that performs a light receiving operation for time-of-flight distance measurement using a modulation frequency; a distance measurement processing unit that performs dual mode distance measurement that causes the pixel array unit to alternately perform a light receiving operation using a first frequency as the modulation frequency and a row receiving operation using a second frequency having a higher frequency than the first frequency as the modulation frequency, and single mode distance measurement that causes the pixel array unit to perform only a light receiving operation using a predetermined frequency as the modulation frequency; and a switching processing unit that switches the distance measurement in the dual mode and the distance measurement in the single mode according to a predetermined condition.

### TECHNICAL FIELD

The present technology relates to a distance measuring device and a sensor device that perform distance measurement, and particularly relates to a distance measuring device and a sensor device that perform time-of-flight distance measurement.

### BACKGROUND ART

There is a time-of-flight method (ToF method) as a distance measurement method.

As the ToF method, an indirect ToF method that does not require a circuit for calculating time has been known. In the indirect ToF method, for example, as disclosed in Patent Document 1, charges obtained by receiving and photoelectrically converting reflected light reflected by an object are distributed to two charge storage units, and a distance to the object is calculated from a ratio of the charge amounts.

### CITATION LIST

### Patent Document

Patent Document 1: Japanese Patent Application Laid-Open No. 2019-004149

### SUMMARY OF THE INVENTION

### Problems to be Solved by the Invention

In such distance measurement using the indirect ToF, the light emitting operation of a light emitting unit and the light receiving operation of a light receiving unit are performed, but there is a problem that a distance measurement distance is shortened when a frequency used for the intensity modulation of the light emitted from the light emitting unit and the light receiving operation of the light receiving unit is increased, and a distance measurement accuracy is deteriorated when the frequency is decreased. Furthermore, considering mounting a module that performs distance measurement by the indirect ToF method on a small device, it is desired to reduce power consumption.

The present technology has been made in view of the above circumstances, and an object thereof is to reduce power consumption while securing distance measurement accuracy and a distance measurement distance in the indirect ToF method.

### Solutions to Problems

A distance measuring device according to the present technology includes: a pixel array unit that performs a light receiving operation for time-of-flight distance measurement using a modulation frequency; a distance measurement processing unit that performs dual mode distance measurement that causes the pixel array unit to alternately perform a light receiving operation using a first frequency as the modulation frequency and a row receiving operation using a second frequency having a higher frequency than the first frequency as the modulation frequency, and single mode distance measurement that causes the pixel array unit to perform only a light receiving operation using a predetermined frequency as the modulation frequency; and a switching processing unit that switches the distance measurement in the dual mode and the distance measurement in the single mode according to a predetermined condition.

In the distance measurement in the dual mode, the irradiation and the light receiving operation of the modulated light intensity-modulated at the first frequency and the irradiation and the light receiving operation of the modulated light intensity-modulated at the second frequency are performed. Therefore, light irradiating and light receiving operations are performed twice in order to obtain distance measurement information once. The distance measurement in the dual mode can achieve both high distance measurement accuracy and long distance measurement.

In addition, in the distance measurement in the single mode, irradiation of modulated light intensity-modulated at a predetermined frequency and a light receiving operation are performed. Therefore, light irradiation and light receiving operations for obtaining distance measurement information only need to be performed once. In the distance measurement in the single mode, power consumption necessary for obtaining one time of distance measurement information is reduced, and a time required for obtaining one time of distance measurement information is also shortened.

A sensor device according to the present technology includes: a pixel array unit in which light receiving elements that perform a unit light receiving operation in time-of-flight distance measurement are two-dimensionally arrayed; and a drive unit that performs, as driving of the pixel array unit, driving in a dual mode in which the light receiving element alternately performs the unit light receiving operation at a first frequency and the unit light receiving operation at a second frequency different from the first frequency, and driving in a single mode in which the light receiving element performs only the unit light receiving operation at a predetermined frequency.

Even in such a sensor device, it is possible to obtain an action similar to that of the distance measuring device according to the present technology described above.

### BRIEF DESCRIPTION OF DRAWINGS

FIG. 1 is a diagram illustrating a configuration example of a distance measuring device according to a first embodiment of the present technology.

FIG. 2 is a diagram schematically illustrating a configuration example of a pixel according to the present technology.

FIG. 3 is a timing chart of signals to be written regarding exposure control and light reception control according to the present technology.

FIG. 4 is a diagram illustrating an operation example in dual mode distance measurement according to the present technology.

FIG. 5 is a diagram illustrating an operation example in distance measurement in a single mode according to the present technology.

FIG. 6 is a diagram illustrating another operation example in distance measurement in a single mode according to the present technology.

FIG. 7 is a diagram illustrating an operation example in a case where distance measurement using a high frequency is performed as a single mode according to the present technology.

FIG. 8 is a diagram illustrating state transition in a distance measurement mode according to the present technology.

FIG. 9 is a flowchart of a processing example executed by a control unit according to the first embodiment of the present technology.

FIG. 10 is a flowchart illustrating an example of initialization processing of an inertial measurement device according to the present technology.

FIG. 11 is a flowchart of a processing example executed by a control unit of a distance measuring device according to a second embodiment of the present technology.

FIG. 12 is a flowchart of another processing example executed by the control unit of the distance measuring device according to the second embodiment of the present technology.

FIG. 13 is a diagram illustrating a configuration example of a distance measuring device according to a third embodiment of the present technology.

FIG. 14 is a flowchart of a processing example executed by a control unit according to the third embodiment of the present technology.

FIG. 15 is a diagram illustrating a configuration example of a distance measuring device according to a fourth embodiment of the present technology.

FIG. 16 is a flowchart of a processing example executed by a control unit according to the fourth embodiment of the present technology.

FIG. 17 is a diagram illustrating a configuration example of a distance measuring device according to a fifth embodiment of the present technology.

### MODE FOR CARRYING OUT THE INVENTION

Hereinafter, embodiments according to the present technology will be described in the following order with reference to the accompanying drawings.
<1. System configuration>
<2. Processing flow>
<3. Second Embodiment>
<4. Third Embodiment>
<5. Fourth Embodiment>
<6. Fifth Embodiment>
<7. Application to imaging device>
<8. Modifications>
<9. Conclusion>
<10. Present technology>

### 1. System Configuration

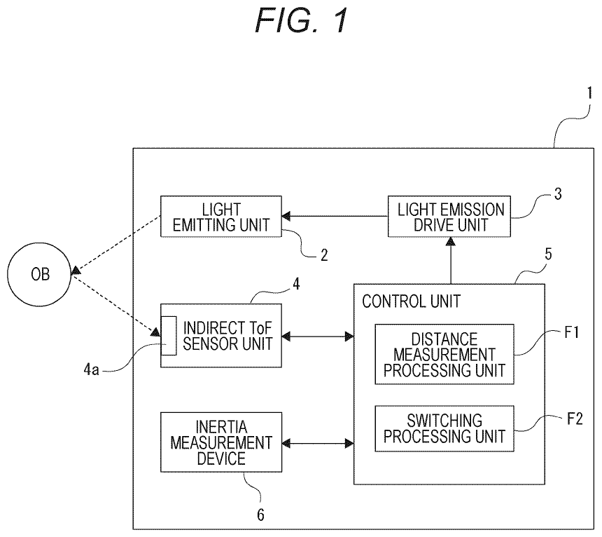

A configuration of a distance measuring device 1 according to a first embodiment will be described with reference to FIG. 1. Note that, as the distance measuring device 1, various devices such as a camera device and a smartphone can be considered.

The distance measuring device 1 includes a light emitting unit 2, a light emission drive unit 3, an indirect ToF sensor unit 4, a control unit 5, and an inertial measurement device 6.

The light emitting unit 2 includes a light source such as an infrared (IR) LED (Light Emitting Diode), for example, and emits light on the basis of a control signal input from the light emission drive unit 3.

The light emitting unit 2 can emit modulated light in which light intensity is modulated on the basis of a specific frequency. In addition, the light emitting unit 2 can emit a plurality of types of modulated light having different specific frequencies. In the present embodiment, it is possible to emit two types of modulated light having different specific frequencies. In the following description, the specific frequency is referred to as a modulation frequency.

The two types of modulation frequencies are a low frequency fL that is a relatively low frequency and a high frequency fH that is a relatively high frequency.

The modulated light modulated on the basis of the low frequency fL is referred to as low frequency modulation light MLL, and the modulated light modulated on the basis of the high frequency fH is referred to as high frequency modulation light MLH.

Note that the light emitting unit 2 may be capable of emitting three or more types of modulated light having different modulation frequencies.

The light emission drive unit 3 supplies a driving signal corresponding to a modulation frequency for emitting the modulated light to the light emitting unit 2.

The indirect ToF sensor unit 4 is a sensor unit of a complementary metal oxide semiconductor (CMOS) type, a charge coupled device (CCD) type, or the like, and is configured as a sensor unit capable of performing distance measurement using an indirect ToF (Indirect ToF) method. The indirect ToF sensor unit 4 includes a pixel array unit 4a configured by two-dimensionally arrayed pixels 7 each including a light receiving element PD.

The indirect ToF sensor unit 4 performs a light receiving operation based on a control signal input from the control unit 5.

The indirect ToF sensor unit 4 receives reflected light in which modulated light emitted from the light emitting unit 2 is reflected by an object OB.

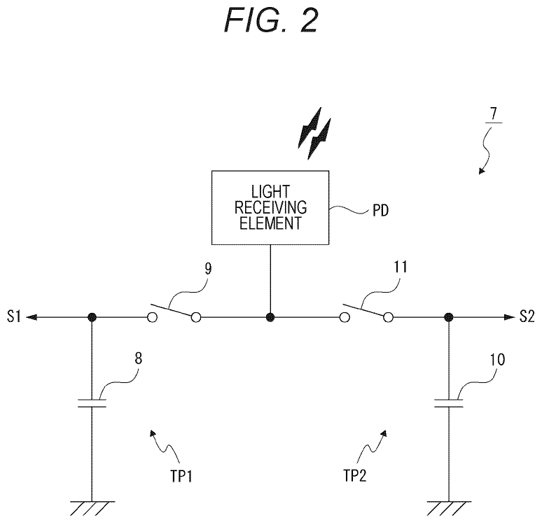

A configuration example of the pixel 7 included in the indirect ToF sensor unit 4 is illustrated in FIG. 2.

The pixel 7 includes a light receiving element PD such as a photodiode, and a first tap TP1 and a second tap TP2 that detect charges generated by photoelectric conversion in the light receiving element PD.

The light receiving element PD in this example has sensitivity to light in an infrared region, for example.

The first tap TP1 includes a first floating diffusion (FD) 8, a first transfer transistor 9 for transferring charge from the light receiving element PD to the first FD 8, a selection transistor and a reset transistor (not illustrated). The first transfer transistor 9 is illustrated as a switch in the drawing.

The second tap TP2 includes a second FD 10, a second transfer transistor 11 for transferring a charge from the light receiving element PD to the second FD 10, and a selection transistor and a reset transistor (not illustrated). The second transfer transistor 11 is illustrated as a switch in the drawing.

In a case where one of the first transfer transistor 9 and the second transfer transistor 11 is controlled to an ON state, the other is controlled to an OFF state. That is, control is performed so that both the first transfer transistor 9 and the second transfer transistor 11 are not simultaneously turned on.

A signal for controlling the ON/OFF state of the first transfer transistor 9 is synchronized with a light emission cycle of a light source included in the light emitting unit 2. In addition, a control signal applied to the first transfer transistor 9 and the second transfer transistor 11 has a phase difference of 180 degrees.

The charge transferred to the first FD 8 is output to the control unit 5 as a first signal S1 which is a detection signal output from the first tap TP1 according to a read signal.

The charge transferred to the second FD 10 is output to the control unit 5 as a second signal S2 which is a detection signal output from the second tap TP2 according to the read signal.

Note that the distance measuring device 1 may include an optical lens system for efficiently causing light to enter the pixel array unit 4a of the indirect ToF sensor unit 4. The optical lens system may include, for example, not only various lenses such as a zoom lens and a focus lens, but also a mechanical shutter, an iris mechanism, and the like.

The description returns to FIG. 1.

The control unit 5 includes, for example, an arithmetic unit such as a central processing unit (CPU), a graphics processing unit (GPU), or a digital signal processor (DSP), and a memory unit such as a read only memory (ROM) or a random access memory (RAM).

Note that the processing executed by the control unit 5 in FIG. 1 may be realized by software, or a part or a front portion thereof may be realized by hardware.

The control unit 5 supplies a command or the like for driving the light emitting unit 2 at a desired modulation frequency to the light emission drive unit 3.

As a result, the light emitting unit 2 can emit light intensity-modulated on the basis of the supplied drive signal of a rectangular wave. Note that the light emitting unit 2 may emit intensity-modulated light on the basis of a sinusoidal drive signal.

Note that the drive signal may be supplied to the light emitting unit 2 not from the control unit 5 but from the indirect ToF sensor unit 4.

In addition, the control unit 5 performs ON/OFF control of the first transfer transistor 9 and the second transfer transistor 11 at timing synchronized with the modulation frequency.

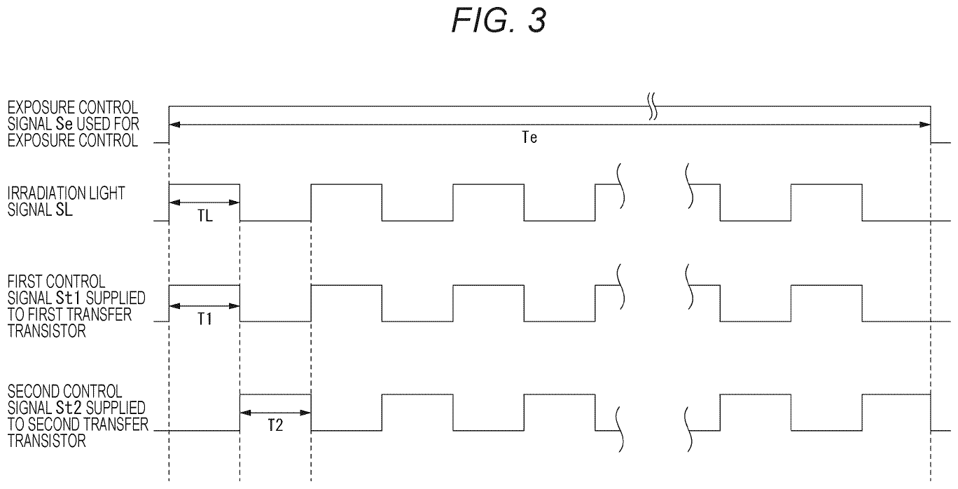

In one exposure time, the control unit 5 performs ON/OFF control a plurality of times (for example, several hundreds of times to several tens of thousands of times). This will be specifically described with reference to FIG. 3. FIG. 3 is a diagram illustrating a relationship among an exposure control signal Se used for exposure control, an irradiation light signal SL provided to the light emitting unit 2 to emit light intensity-modulated at a predetermined modulation frequency, a first control signal St1 supplied to the first transfer transistor 9, and a second control signal St2 supplied to the second transfer transistor 11.

The first transfer transistor 9 is ON/OFF controlled on the basis of the first control signal St1. In addition, the second transfer transistor 11 is ON/OFF controlled on the basis of the second control signal St2.

As illustrated, during an exposure time Te, light irradiation is performed a plurality of times over an irradiation period TL. An operation of performing one light irradiation, that is, one light irradiation in the irradiation period TL is referred to as a “unit light emission operation”. The light irradiation is performed a plurality of times by alternately repeating the light irradiation period TL and a light non-irradiation period. The light non-irradiation period is the same time length as the irradiation period TL. That is, a duty ratio is 50%.

The control unit 5 performs switching control of the first transfer transistor 9 so that charges are accumulated in the first FD 8 over the first period T1 synchronized with the irradiation light signal SL. In addition, the control unit 5 performs switching control of the second transfer transistor 11 so that charges are accumulated in the second FD 10 over the second period T2 synchronized with the irradiation light signal SL. The first period T1 and the second period T2 have the same time length as the irradiation period TL.

As a result, charges are intermittently accumulated in the first FD 8 and the second FD 10 several hundred times, several 1000 times, or several tens of thousands times.

In a case where the amount of received light for one cycle of irradiation light is very small, there is a possibility that significant data cannot be acquired. Therefore, light is received for several hundred to several tens of thousands cycles to accumulate charges, so that a sufficient amount of received light can be obtained, and significant information can be acquired.

One operation of accumulating charges in correspondence with the unit light emission operation (first period T1) is referred to as “unit light receiving operation”.

Note that switching of the switch may be performed once such that the first FD 8 and the second FD 10 each accumulate charges once in one exposure time Te. That is, the first transfer transistor 9 may be controlled to the ON state so that the first FD 8 accumulates the charge in a first half of the exposure time Te, and switching control may be performed to switch the first transfer transistor 9 to the OFF state and the second transfer transistor 11 to the ON state at the start of a second half of the exposure time Te, so that the charge is accumulated in the second FD 10 in the second half of the exposure time.

The description returns to FIG. 1.

The control unit 5 includes a distance measurement processing unit F1 and a switching processing unit F2 in order to realize various functions described later.

The distance measurement processing unit F1 performs distance measurement by performing light emission control of the light emitting unit 2 and light reception control of the indirect ToF sensor unit 4 using one or a plurality of different frequencies.

The distance measurement processing unit F1 can perform distance measurement in a plurality of distance measurement modes. Specifically, the distance measurement processing unit F1 can use a dual mode DM that performs distance measurement using two types of different frequencies (for example, a low frequency fL and a high frequency fH) and a single mode SM that performs distance measurement using only a single frequency.

In the dual mode DM, a distance measurement distance is secured by using a result of distance measurement using the low frequency fL, and distance measurement accuracy is secured by using a result of distance measurement using the high frequency fH. That is, the dual mode DM is a mode for securing performance of both the distance measurement distance and the distance measurement accuracy.

For example, in the distance measurement using the low frequency fL, the distance measurement can be performed in a range of 0 m to 5 m in 100 steps (5 cm increments). That is, in the distance measurement at the low frequency fL, the distance measurement distance is 5 m, and the resolution is 5 cm.

Furthermore, in the distance measurement using the high frequency fH, the range of 0 m to 1 m can be measured in 100 steps (1 cm increments). That is, in the distance measurement at the high frequency fH, the distance measurement distance is 1 m, and the resolution is 1 cm.

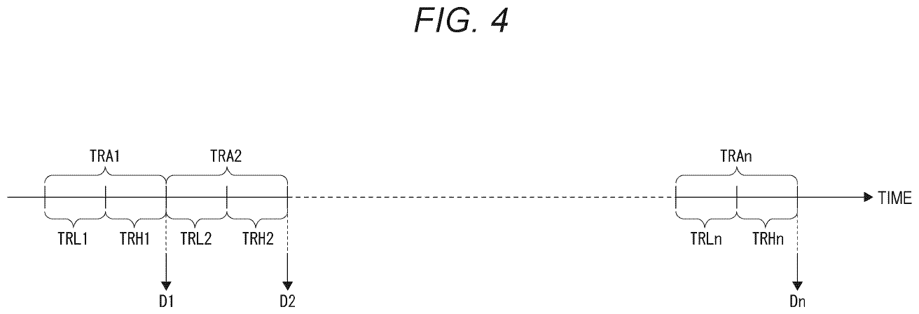

FIG. 4 illustrates an example of distance measurement in the dual mode DM.

Assuming that a period in which distance measurement using the low frequency fL is executed is a period TRL and a period in which distance measurement using the high frequency fH is executed is a period TRH, one distance measurement is performed with the period TRL and the period TRH as a set (see FIG. 4). This period is defined as a period TRA. A distance measurement data D is calculated after the period TRA elapses.

The distance measurement data D calculated here is measured at intervals of 1 cm between 0 m and 5 m. That is, performance of both the distance measurement distance of 5 m and the distance measurement accuracy in increments of 1 cm is secured.

In this manner, a distance measurement data D1 is calculated after a period TRA1 including a period TRL1 and a period TRH1 elapses, and a next distance measurement data D2 is calculated after a period TRA2 including a period TRL2 and a period TRH2 elapses.

Note that the light emitting unit 2 emits the low frequency modulation light MLL in the period TRL1 and emits the high frequency modulation light MLH in the period TRH1. That is, the light emitting unit 2 repeats the irradiation period TL and the non-irradiation period without a break during the execution of the distance measurement in the dual mode DM.

Note that in the dual mode DM, the order of the period TRL and the period TRH may be reversed.

In the single mode SM, only a result of distance measurement using either the low frequency fL or the high frequency fH is used. In the distance measurement in the single mode SM, there is a possibility that performance of either the distance measurement accuracy or the distance measurement distance is sacrificed.

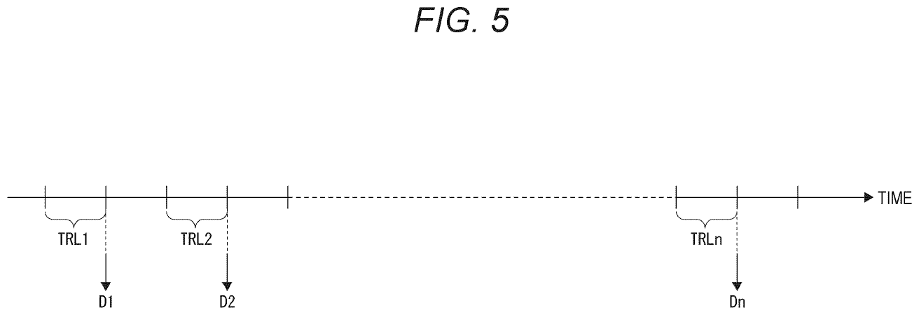

An example of distance measurement in the single mode SM is illustrated in FIG. 5. Note that FIG. 5 is an example in which only distance measurement using the low frequency fL is performed. In a case where the distance measurement data D is output at the same frequency as the dual mode DM, the distance measurement data D is calculated after the period TRL in which the distance measurement using the low frequency fL is executed, and then a distance measurement non-execution period having the same length as the period TRL is provided.

In this manner, after the distance measurement data D1 is calculated after the period TRL1 has elapsed, the distance measurement data D2 is calculated after the period TRL2 has elapsed with the distance measurement non-execution period interposed therebetween.

In the single mode SM, a period (distance measurement non-execution period) in which the light emitting unit 2 does not emit light after emitting the low frequency modulation light MLL in the period TRL1 is provided. As a result, the number of light emission times and the light receiving operation in the pixel array unit 4a can be reduced with respect to the dual mode DM, and the power consumption can be reduced.

Note that, in the example illustrated in FIG. 5 in the single mode SM, the period TRL1 and the distance measurement non-execution period have the same time length. However, the distance measurement non-execution period may be shorter than the period TRL1. As a result, the power consumption can be reduced with respect to the dual mode DM, and the resolution of the distance measurement result in a time axis direction can be enhanced.

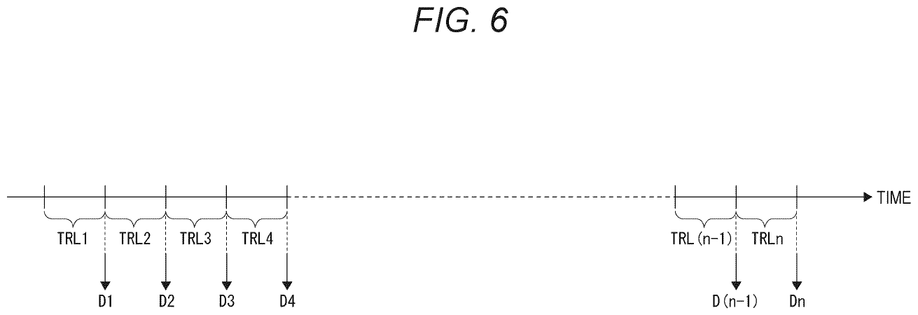

Note that the distance measurement non-execution period may not be provided in the single mode SM (see FIG. 6).

As a result, it is possible to substantially double the resolution in the time axis direction as compared with the dual mode DM.

In a case where distance measurement using the high frequency fH is performed in the single mode SM, distance measurement data measured last in the dual mode DM is used. As a result, both performances of the distance measurement accuracy and the distance measurement distance are secured in the distance measurement of the single mode SM.

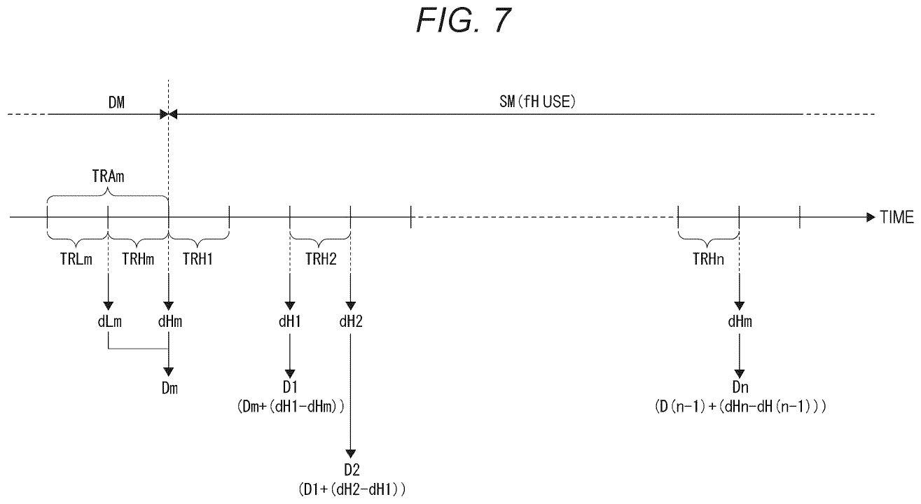

This will be specifically described with reference to FIG. 7.

It is assumed that after m times of distance measurement data D are acquired in the dual mode DM, the mode is switched to the single mode SM. A first distance measurement in the single mode SM is performed in the period TRH1 using the high frequency fH. An intermediate data dH1 is obtained after the period TRH1 elapses. An intermediate data dH is distance measurement data obtained using the high frequency fH and is highly accurate distance measurement data. However, the intermediate data dH alone is data whose accurate distance is unclear due to a problem of periodicity of the distance measurement data.

Therefore, an m-th distance measurement data Dm (that is, the last distance measurement data) acquired in the dual mode DM is used.

Specifically, the distance measurement data Dm is calculated from an intermediate data dLm acquired last in the dual mode DM using the low frequency fL and an intermediate data dHm acquired last in the dual mode DM using the high frequency fH.

The first distance measurement data D1 in the single mode SM is obtained by considering a difference between the intermediate data dHm and the intermediate data dH1 with respect to the immediately preceding distance measurement data Dm. That is, the distance measurement data D1 is obtained by adding the difference between the intermediate data dHm and the intermediate data dH1 to the immediately preceding distance measurement data Dm.

The second distance measurement data D2 in the single mode SM is obtained by adding a difference between the intermediate data dH2 and the intermediate data dH1 to the immediately preceding distance measurement data D1.

With use of the distance measurement data D and the intermediate data dH acquired in the dual mode DM in this manner, in a case where distance measurement using the high frequency fH is performed in the subsequent single mode SM, it is possible to suppress power consumption by reducing the number of times of light emission while securing both performance of the distance measurement distance and the distance measurement accuracy.

The switching processing unit F2 performs switching processing of the distance measurement mode. In the present embodiment, the switching processing unit F2 switches between the dual mode DM and the single mode SM on the basis of a signal output from the inertial measurement device 6.

The indirect ToF sensor unit 4 includes a drive unit that drives the pixel array unit 4a corresponding to the dual mode DM or the single mode SM, and the drive unit switches the driving of the pixel array unit 4a in the dual mode DM and the driving of the pixel array unit 4a in the single mode SM on the basis of the switching signal by the switching processing unit F2.

The inertial measurement device 6 is also called an inertial measurement unit (IMU), and includes an acceleration sensor and an angular velocity sensor for detecting the movement and the posture of the distance measuring device 1. The output of the inertial measurement device 6 is set to “0”, for example, in a case where the distance measuring device 1 does not move and stays at the same place and there is no change in posture, for example, in a case where the distance measuring device 1 is installed on a desk and no person touches the distance measuring device 1. Then, a signal other than “0” is output in a case where the distance measuring device 1 is moving or the posture is changing.

The switching processing unit F2 switches the distance measurement mode in a case where the output from the inertial measurement device 6 satisfies a predetermined condition. For example, in a case where the output from the inertial measurement device 6 is equal to or greater than a threshold, the switching processing unit F2 may switch the distance measurement mode by estimating that the angle of view varies, or in a case where the output from the inertial measurement device 6 is less than the threshold, the switching processing unit F2 may switch the distance measurement mode by estimating that the angle of view does not vary.

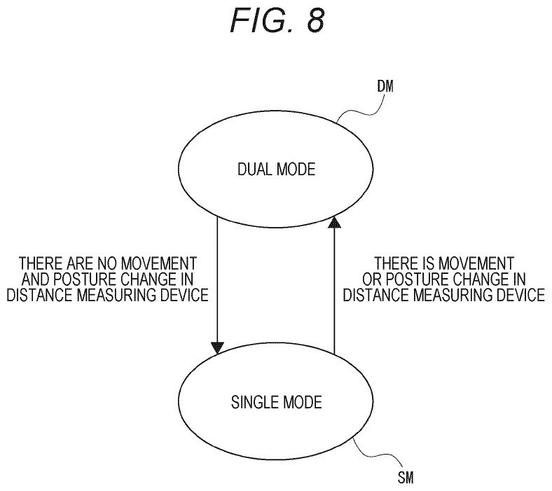

An example of a state transition for the distance measurement mode is illustrated in FIG. 8. In a case where it is determined that there is no movement and posture change of the distance measuring device 1 in the dual mode DM, the switching processing unit F2 switches to the single mode SM.

In a case where there is no movement and posture change of the distance measuring device 1, there is a high possibility that the last distance measurement data acquired in the dual mode DM, specifically, the intermediate data dL which is the distance measurement data using the low frequency fL can be used as it is. Therefore, the distance measurement mode is switched to the single mode SM and only the intermediate data dH using the high frequency fH is continuously acquired, so that it is possible to realize low power consumption of the distance measuring device 1 by eliminating unnecessary distance measuring operation as much as possible.

In addition, the switching processing unit F2 switches the mode to the dual mode DM in a case where it is determined that there is movement or posture change of the distance measuring device 1 in the single mode SM.

In a case where the movement or posture change of the distance measuring device 1 occurs, there is a high possibility that it is necessary to update the past intermediate data dL that has been used so far. Therefore, the distance measurement mode is switched to the dual mode DM to obtain detailed distance information for each object OB, thereby preventing a decrease in the distance measurement accuracy.

As described above, the switching processing unit F2 switches to the dual mode DM capable of performing high-accuracy and long-distance measurement as necessary while obtaining the power consumption reduction effect by using the single mode SM. That is, the switching processing unit F2 can properly use the single mode SM and the dual mode DM.

### 2. Flow of Processing

A flow of processing executed by the control unit 5 of the distance measuring device 1 in a first embodiment will be described with reference to the accompanying drawings.

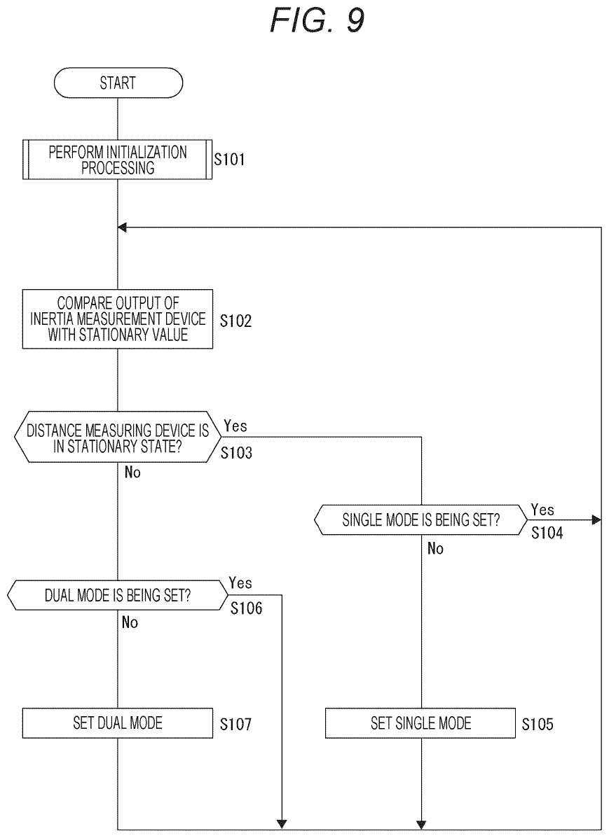

First, the control unit 5 performs initialization processing in step S101 of FIG. 9. In the initialization processing, reference data of the inertial measurement device 6 is acquired.

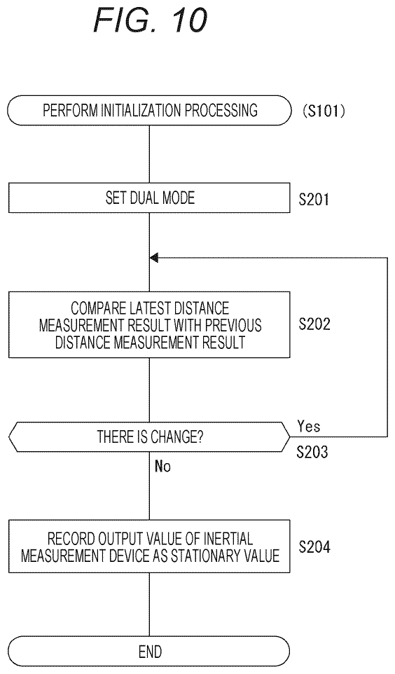

Specifically, the control unit 5 sets the dual mode DM in step S201 of the initialization processing of FIG. 10. Thereafter, distance measurement using the low frequency fL and distance measurement using the high frequency fH are performed until the distance measurement mode is changed or until the power supply of the distance measuring device 1 is turned off.

Subsequently, in step S202, the control unit 5 compares the latest distance measurement data with the previous distance measurement data. Then, in step S203, the control unit 5 performs branch processing based on the comparison result. Specifically, in a case where the control unit 5 determines in step S203 that there is a change in the position or posture of the distance measuring device 1, the control unit 5 returns to the processing of step S202 again.

On the other hand, in a case where it is determined that there is no change in the position and posture of the distance measuring device 1, the control unit 5 records an output value of the inertial measurement device 6 as a stationary value in step S204.

With the execution of the processing of step S204, the initialization processing illustrated in FIG. 10 ends.

The description returns to FIG. 9. In step S102, the control unit 5 compares the latest output of the inertial measurement device 6 with a stationary value.

In step S103, the control unit 5 performs branch processing based on the comparison result. Specifically, in step S103, the control unit 5 determines whether or not the distance measuring device 1 is in a stationary state. In this determination processing, it is determined that the distance measuring device 1 is in a stationary state in a case where the output of the inertial measurement device 6 is lower than the threshold, and it is determined that the distance measuring device 1 is not in the stationary state in a case where the output of the inertial measurement device 6 is equal to or greater than the threshold.

In a case where it is determined that the distance measuring device 1 is in the stationary state, the control unit 5 determines whether or not the single mode SM is being set in step S104.

In a case where the single mode SM is being set, the control unit 5 returns to the processing of step S102. On the other hand, in a case where it is determined that the distance measuring device 1 is being set to the dual mode DM even though the distance measuring device 1 is in the stationary state, the control unit 5 sets the single mode SM in step S105, and the process returns to step S102.

In a case where it is determined that the distance measuring device 1 is not in the stationary state in the processing of step S103, the control unit 5 determines whether or not the dual mode DM is being set in step S106.

Then, in a case where it is determined that the dual mode DM is being set, the control unit 5 returns to the processing of step S102. On the other hand, in the case where it is determined that the single mode SM is being set even though the distance measuring device 1 is moving, the control unit 5 sets the dual mode DM in step S107 and returns to the processing of step S102.

As an example of switching between the dual mode DM and the single mode SM in this manner, for example, a camera device that captures a landscape, a port rate, or the like can be considered.

Specifically, in a case where it is detected by the output of the inertial measurement device 6 that an image is captured with the camera device held in the hand, distance measurement in the dual mode DM is performed. On the other hand, in a case where it is detected by the output of the inertial measurement device 6 that an image is captured using a tripod or an image is captured in a state where the tripod is installed on a desk or the like, distance measurement in the single mode SM is performed.

Such an example can also be applied to mobile terminal devices such as smartphones and tablets. For example, a state will be considered in which a camera of a mobile terminal device (distance measuring device 1) is oriented toward and visually recognized from a virtual object as augmented reality placed at a predetermined position on a desk.

In a case where the virtual object is being imaged with the mobile terminal device held in a hand in order to view the virtual object from various angles, it is possible to fix the virtual object at a fixed point by measuring a distance to a real object (desk or the like) located around the virtual object with high accuracy. In such a case, distance measurement in the dual mode DM is performed. In addition, in a case where the mobile terminal device is fixed on a desk using a stand or the like and a virtual object is imaged, distance measurement in the single mode SM is performed. As a result, the number of times of light emission and the light receiving operation can be reduced, and the mobile terminal device can be operated for a long time.

### 3. Second Embodiment

In a second embodiment, a modulation frequency used for a light emission control and a light reception control in a single mode SM is selected from a low frequency fL and a high frequency fH.

In the following description, in a case where distance measurement using the low frequency fL is performed in a single mode SM, the mode is described as a single mode SML, and in a case where distance measurement using the high frequency fH is performed in the single mode SM, the mode is described as a single mode SMH.

For example, consider a case where a customer service robot that serves a customer includes a distance measuring device 1. While the customer service robot stands at an entrance of a store and waits for the customer to pass in front of the customer service robot, the distance measuring device 1 is brought into a stationary state, and thus the single mode SM is selected. Since high distance measurement accuracy is not required to determine whether or not a person passes, distance measurement using the low frequency fL is performed.

On the other hand, in a case where it is detected that the customer stops in front of the customer service robot, the distance measuring device 1 performs the distance measurement for the customer with high accuracy by transitioning the distance measurement mode to a dual mode DM, and then transitions to the single mode SM. At this time, in a case where the response (movement) of the customer service robot is changed according to the small movement of the customer, the distance measurement mode after the transition is set to the single mode SMH in which the distance measurement is performed using the high frequency fH.

As described above, even in the same single mode SM, it is possible to selectively use the single mode SML and the single mode SMH according to the situation.

In addition to the customer service robot, various examples such as a pet robot can be considered.

Furthermore, a case where the monitoring camera includes the distance measuring device 1 will be considered. It is assumed that the monitoring camera includes a swing mode for monitoring a range wider than the angle of view and a fixed point observation mode for monitoring whether or not an object moving in the angle of view is present.

In the swing mode, the dual mode DM is selected as the distance measurement mode.

On the other hand, in a fixed point observation mode, the single mode SML is basically selected. Then, in a case where an object moving within the angle of view is detected, highly accurate distance measurement for the moving object is performed through the dual mode DM, and then the mode transitions to the single mode SMH.

As described above, the switching processing unit F2 of the control unit 5 in the present embodiment can execute the selection processing of selecting either the low frequency fL or the high frequency fH as the frequency used for the single mode SM.

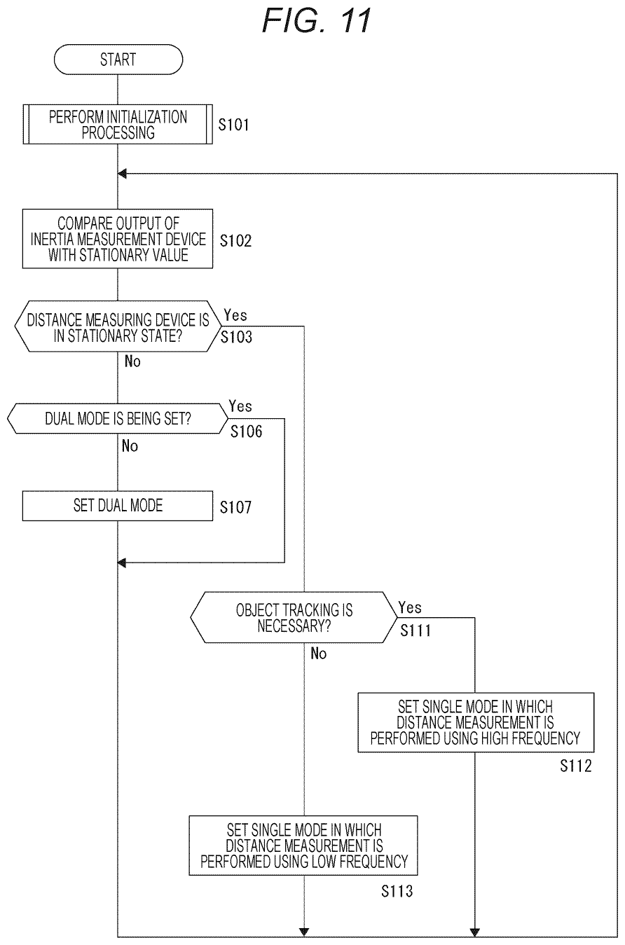

An example of processing executed by the control unit 5 is illustrated in FIG. 11. Note that processing similar to that in FIG. 9 will be denoted by the same step number, and description thereof will be omitted as appropriate.

In a case where it is determined in step S103 that the distance measuring device 1 is in a stationary state, the control unit 5 determines in step S111 whether or not object tracking is necessary. In a case where the object tracking is determined to be necessary, in step S112, the control unit 5 sets the single mode SMH in which the distance measurement is performed using the high frequency fH. Note that the change of the distance measurement mode at this time may not only change from the dual mode DM to the single mode SMH, but also change from the single mode SML to the single mode SMH. Furthermore, in this case, the single mode SML may be changed to the single mode SMH through the dual mode DM.

In a case where it is determined in step S111 that the object tracking is not necessary, the control unit 5 sets the single mode SML in which the distance measurement is performed using the low frequency fL in step S113. The change of the distance measurement mode at this time may be not only a change from the dual mode DM but also a change from the single mode SMH. Then, at that time, the mode may be changed through the dual mode DM.

Note that, here, an example in which the single mode SML using the low frequency fL and the single mode SMH using the high frequency fH are selectively used according to the situation has been described. However, which single mode SM is used may be determined in advance depending on a device on which the distance measuring device 1 is mounted. Furthermore, the determination may be selected by the user in advance. That is, instead of the processing of step S111, it may be determined which single mode SM is selected by the user, and the process may be branched to the processing of step S112 or step S113.

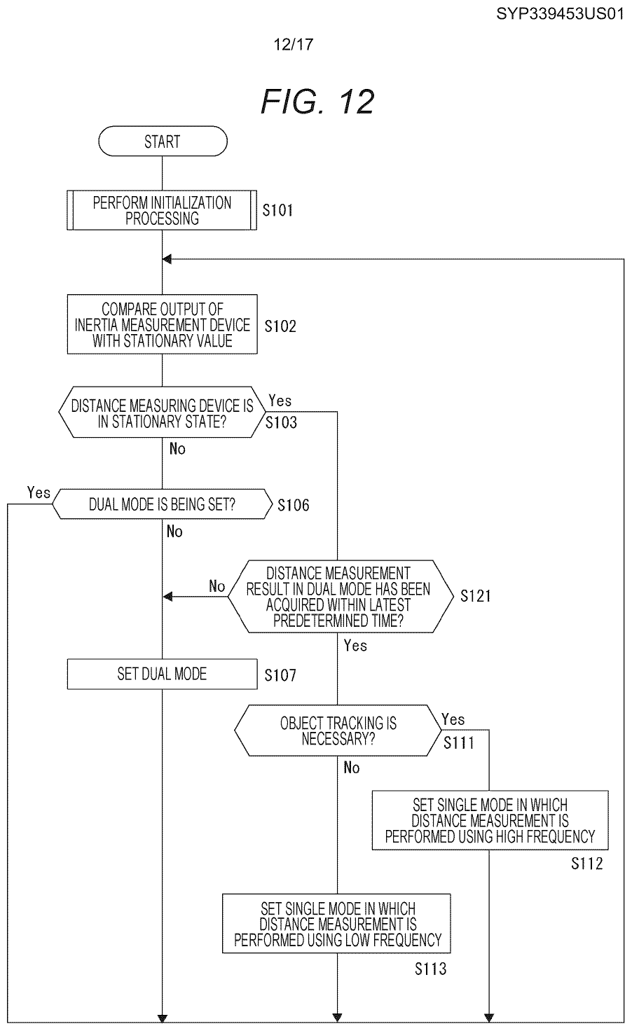

Note that, in a case where a stationary state of the distance measuring device 1 continues for a long time, it may be better to update the distance measurement data in the dual mode DM used in the single mode SM. For example, even if the angle of view of the distance measuring device 1 has not changed, the object OB in the angle of view moves greatly, and it is better to perform distance measurement again in the dual mode DM. An example of processing in that case is illustrated in FIG. 12. Note that processes similar to those in FIGS. 9 and 11 are denoted by the same step numbers, and description thereof is omitted as appropriate.

In a case where it is determined in step S103 that the distance measuring device 1 is in the stationary state, the control unit 5 determines in step S121 whether or not the distance measurement data in the dual mode DM has been acquired within the latest predetermined time. In a case where it is determined that the distance measurement in the dual mode DM has not been performed within the latest predetermined time and the distance measurement data (intermediate data dH) in the dual mode DM should be updated (“No” determination in the drawing), the control unit 5 proceeds to step S107 and changes the distance measurement mode to the dual mode DM.

On the other hand, in a case where the distance measurement in the dual mode DM has been performed within the latest predetermined time and it is determined that the distance measurement data in the dual mode DM is new (“Yes” determination in the drawing), the control unit 5 proceeds to the processing of step S111 and determines whether to change the distance measurement mode to the single mode SML or the single mode SMH.

Note that, in a case where the changed distance measurement mode has already been set, the processing of step S112 or step S113 may be omitted.

As in the present embodiment, with a configuration in which the distance measuring device 1 to be able to select the frequency of the signal used for the light emitting operation and the light receiving operation of the single mode SM according to the situation, a suitable frequency can be selected according to the situation and used for distance measurement.

In addition, as described above, since a desired frequency can be selected from options prepared in advance such as the low frequency fL and the high frequency fH, it is not necessary to provide a configuration for calculating a frequency used for light emission control and light reception control, and the configuration of the distance measuring device 1 can be downsized.

Note that, in the single mode SML, the mode may be changed to the single mode SMH in a case where the distance measurement data of the object within the angle of view is less than a predetermined value, for example, only the object within the distance measurable by the distance measurement using the high frequency fH is located within the angle of view.

For example, it is conceivable that a user carrying a smartphone as the distance measuring device 1 moves into a room and performs selfie with a wall or the like as a back. At this time, the distance information about the user or the wall as the object may be about 1 m, and in that case, the mode is changed to the single mode SMH, so that it is possible to achieve both high distance measurement accuracy and low power consumption.

### 4. Third Embodiment

A distance measuring device 1A according to a third embodiment has a function of calculating an optimum frequency (hereinafter, referred to as “optimum frequency fS”) as a frequency used in a single mode SM.

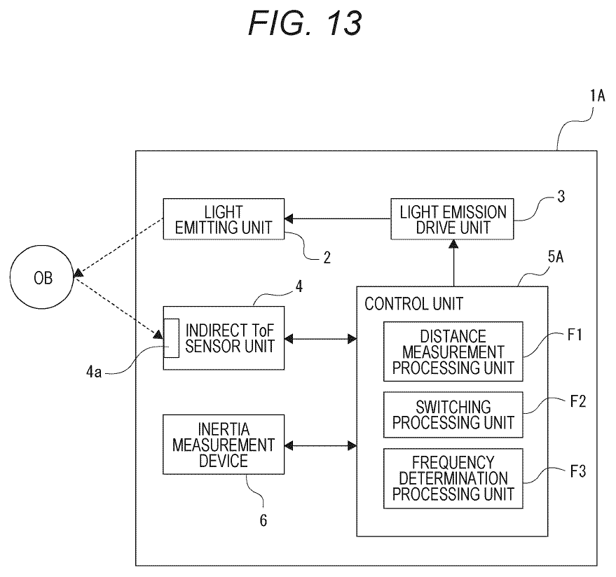

Specifically, as illustrated in FIG. 13, a control unit 5A of the distance measuring device 1A includes a frequency determination processing unit F3 in addition to a distance measurement processing unit F1 and a switching processing unit F2.

The frequency determination processing unit F3 calculates and determines the optimum frequency fS on the basis of distance information output from an indirect ToF sensor unit 4.

For example, a frequency used in the single mode SM is determined according to the largest value (distance) in the distance information for each pixel output from the indirect ToF sensor unit 4.

For example, in a case where the largest value is 2 m, the optimum frequency fS is calculated and determined so that the distance measurement distance becomes 3 m (2 m plus 1 m). In addition, in a case where the largest value is 5 m, the optimum frequency fS is calculated and determined so that the distance measurement distance becomes 6 m (obtained by adding 1 m to 5 m).

Various methods for determining the optimum frequency fS can be considered. For example, as described above, the optimum frequency fS may be determined so that a value obtained by adding a predetermined distance to the maximum value of the distance measurement data becomes the distance measurement distance, or the optimum frequency fS may be determined so that a value obtained by multiplying the maximum value of the distance measurement data by a predetermined coefficient such as 1.1 or 1.2 becomes the distance measurement distance.

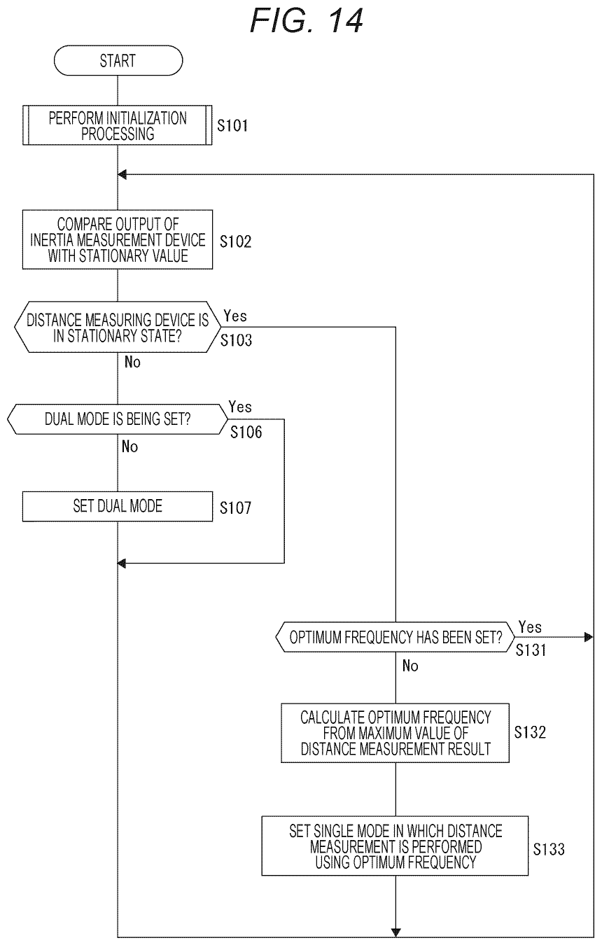

An example of processing executed by the control unit 5 in the present embodiment will be described with reference to FIG. 14. Note that processing similar to that in FIG. 9 will be denoted by the same step number, and description thereof will be omitted as appropriate.

In a case where it is determined in step S103 that the distance measuring device 1A is in a stationary state, the control unit 5 determines in step S131 whether or not the optimum frequency fS has been set. In a case where the optimum frequency fS has been set, that is, in a case where the single mode SM for performing distance measurement using the calculated optimum frequency fS has been set, the control unit 5 returns to step S102 and continues distance measurement in the single mode SM.

On the other hand, in a case where it is determined in step S131 that the optimum frequency fS has not been set, the control unit 5 calculates the optimum frequency fS from the maximum value of the distance measurement data in step S132, and sets the single mode SM in which distance measurement is performed using the optimum frequency fS in subsequent step S133.

As a result, it is possible to improve the accuracy of distance measurement while securing a necessary distance measurement distance.

Note that the set optimum frequency fS may be reset every time the dual mode DM is passed. That is, when the processing of step S131 is executed in the dual mode DM, it may be always determined that the optimum frequency fS has not been set. As a result, the optimum frequency fS can be reset every time the mode transitions from the dual mode DM to the single mode SM.

Note that, in a case where the optimum frequency fS has been changed, the number of times of light emission of the light emitting unit 2 in one distance measurement, that is, the number of times of unit light emission operation may be optimized.

For example, in a case where the distance measurement distance is long and the optimum frequency fS is low, an object OB far from the distance measuring device 1A is also included. There is a high possibility that the reflected light reflected by the object OB cannot be received by the indirect ToF sensor unit 4. In particular, as illustrated in FIG. 3, in a case where the light emitting unit 2 emits light several tens of thousands times to several 100,000 times in one distance measurement, one light emission time (irradiation period TL) becomes short, and thus, there is a case where the reflected light cannot be received in the unit light receiving operation based on the unit light emitting operation.

On the other hand, in a case where the distance measurement distance is short and the optimum frequency fS is high, only the object OB having a short distance from the distance measuring device 1A is present. There is a high possibility that the reflected light reflected by the object OB can be received in the unit light receiving operation of the indirect ToF sensor unit 4.

Therefore, as shown in FIG. 3, there is a high possibility that significant distance information can be acquired before the unit light emission operation of the light emitting unit 2 is performed several tens of thousands times to several 100,000 times in one distance measurement (period TRL).

In view of such a situation, the number of unit light emission operations of the light emitting unit 2 may be reduced as the determined optimum frequency fS is higher, and the time (period TRL) related to one distance measurement may be shortened.

For example, as illustrated in FIG. 5, in a case where distance measurement (period TRL) is intermittently performed in the single mode SM, the distance measurement non-execution period can be lengthened by shortening the period TRL, and power consumption can be further reduced.

Furthermore, in a case where the distance measurement in the single mode SM is performed without providing the distance measurement non-execution period as illustrated in FIG. 6, the resolution in the time axis direction can be further enhanced by the shortened period TRL.

### 5. Fourth Embodiment

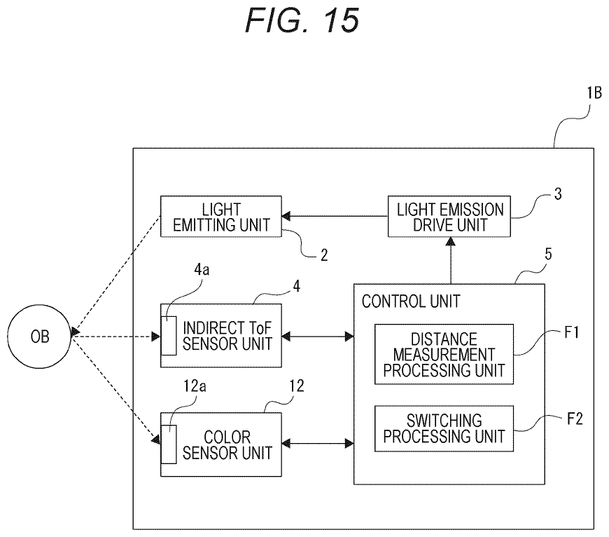

A distance measuring device 1B in a fourth embodiment includes a color sensor unit 12 instead of the inertial measurement device 6 (see FIG. 15).

The color sensor unit 12 is provided to estimate a change in the angle of view of the distance measuring device 1B.

The color sensor unit 12 is, for example, an RGB (Red, Green, Blue) sensor unit. The color sensor unit 12 includes a pixel array unit 12a in which pixels provided with color filters are two-dimensionally arrayed, and each pixel is provided as any of a pixel that receives red light, a pixel that receives green light, and a pixel that receives blue light.

The distance measuring device 1B may include the above-described optical lens system in order to cause light to efficiently enter the pixel array unit 12a of the color sensor unit 12.

Note that the color sensor unit 12 may be a CMY (Cyan, Magenta, Yellow) sensor unit.

A control unit 5 analyzes a pixel signal output from each pixel of the color sensor unit 12 to perform processing of detecting a variation of a feature point in the angle of view.

A switching processing unit F2 of the control unit 5 switches between a dual mode DM and a single mode SM on the basis of the detection result of the variation of the feature point.

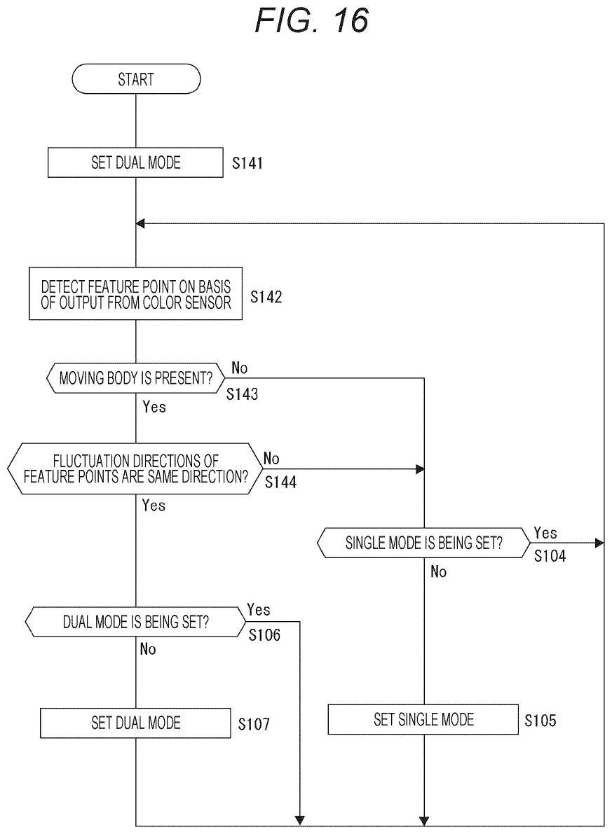

Specifically, an example of processing executed by the control unit 5 in the present embodiment will be described with reference to FIG. 16.

Note that processing similar to that in FIG. 9 will be denoted by the same step number, and description thereof will be omitted as appropriate.

First, in step S141, the control unit 5 sets the dual mode DM.

Subsequently, in step S142, the control unit 5 detects a feature point on the basis of the output from the color sensor unit 12. The change in the feature point is analyzed, so that it is possible to determine whether or not the distance measuring device 1B is in a stationary state.

Specifically, in step S143, the control unit 5 determines the presence or absence of a moving body. The moving object is an object OB determined to move within the angle of view.

In a case where there is no moving body, it can be estimated that the distance measuring device 1B is in a stationary state. Therefore, the control unit 5 proceeds to step S104 to set the single mode SM.

On the other hand, in a case where it is determined in step S143 that there is a moving body, the control unit 5 determines in step S144 whether or not the fluctuation directions of the feature points are the same direction.

In a case where the fluctuation directions of the feature points are not the same direction, it can be estimated that a moving object has been detected due to movement of the object OB within the angle of view. That is, it can be estimated that the angle of view of the distance measuring device 1B does not vary. Therefore, the control unit 5 proceeds to step S104 to set the single mode SM.

On the other hand, in a case where it is determined that the fluctuation directions of the feature points are the same direction, it is estimated that the object OB is detected as a moving object because the angle of view of the distance measuring device 1B fluctuates. That is, it is estimated that the movement or the posture change of the distance measuring device 1B has occurred.

In this case, the control unit 5 proceeds to step S106 to set the dual mode DM.

With the provision of the color sensor unit 12 such as an RGB sensor unit or a CMY sensor unit as an alternative sensor of the indirect ToF sensor unit 4, it is possible to detect a change in the angle of view of the distance measuring device 1B such as a camera device or a mobile terminal device on which both sensors are mounted. In particular, in a case where many of the feature points within the angle of view fluctuate in the same direction, it can be determined that a posture change of the distance measuring device 1B has occurred, and it is possible to suitably switch to the dual mode DM.

### 6. Fifth Embodiment

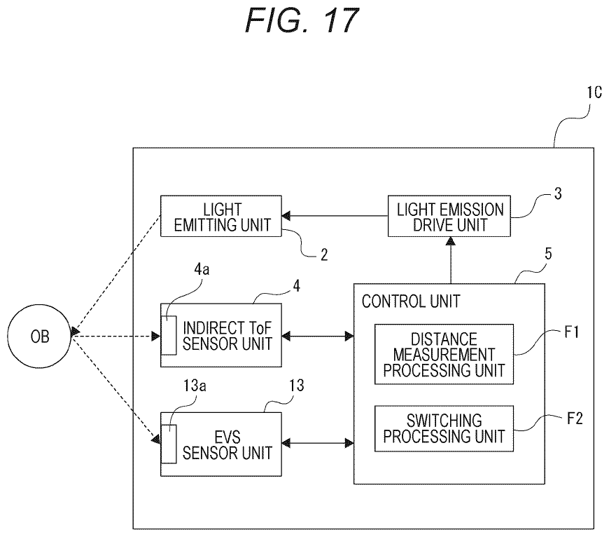

A distance measuring device 1C in the fifth embodiment includes an event-based vision sensor unit 13 (hereinafter, referred to as “EVS sensor unit 13”) instead of the inertial measurement device 6 (see FIG. 17).

The EVS sensor unit 13 includes a pixel array unit 13a, an arbiter (not illustrated), a reading unit, a signal processing unit, a memory unit, an output unit, and the like.

In the pixel array unit 13a, pixels are arranged in a two-dimensional array in a row direction (horizontal direction) and a column direction (vertical direction). Each pixel included in the pixel array unit 13a detects the presence or absence of an event depending on whether or not the amount of change in the amount of received light exceeds a predetermined threshold, and outputs a request to the arbiter when the event occurs.

The arbiter arbitrates a request from each pixel and controls a read operation by the reading unit.

The reading unit performs a reading operation on each pixel of the pixel array unit 13a on the basis of the control of the arbiter. The read operation is executed, for example, at a timing corresponding to the vertical synchronization signal.

Each pixel of the pixel array unit 13a outputs a signal based on a difference between the reference level and the current level of the light reception signal according to the read operation by the reading unit.

The signal read from each pixel is stored in the memory unit as a differential signal.

Each pixel of the pixel array unit 13a resets the reference level to the level of the current light reception signal according to the output of the difference signal. As a result, it is possible to detect the amount of change in the light reception amount with respect to the reference level according to the next vertical synchronization signal.

The reading of the difference signal and the resetting of the reference level are not performed until the amount of change in the light reception amount exceeds the predetermined threshold.

As a result, a difference signal corresponding to the integrated amount of change in the amount of received light is output from the pixel.

In the EVS sensor unit 13, as compared with the color sensor unit 12 described above, the readout target pixel is limited to the pixel in which the change in the light reception amount is detected, and thus, it is possible to reduce the power consumption related to the readout.

Note that the distance measuring device 1C may be configured to include the above-described optical lens system in order to cause light to efficiently enter the pixel array unit 13a of the EVS sensor unit 13.

The control unit 5 performs processing of detecting a moving object in the angle of view and detecting a variation of a feature point by analyzing a difference signal output from each pixel of the EVS sensor unit 13. Then, the control unit 5 switches between the dual mode DM and the single mode SM on the basis of the detection result.

The control unit 5 includes a distance measurement processing unit F1 and a switching processing unit F2. Since each unit has the similar function to the other embodiments described above, the description thereof will be omitted.

In addition, the processing executed by the control unit 5 is similar to that illustrated in FIG. 16, and the description thereof will be omitted.

The distance measuring device 1C according to the present embodiment includes an EVS sensor unit 13 as a sensor unit other than the indirect ToF sensor unit 4, and the control unit 5 detects the view angle variation of the EVS sensor unit 13 on the basis of the output from the EVS sensor unit 13, switches to the distance measurement in the dual mode DM in a case where it is determined that there is the view angle variation, and switches to the distance measurement in the single mode SM in a case where it is determined that there is no view angle variation.

With the provision of the EVS sensor unit 13 in addition to the indirect ToF sensor unit 4, it is possible to detect a change in the angle of view of a camera device, a mobile terminal device, or the like on which both the sensors are mounted. This makes it possible to estimate that a posture change of the device has occurred, and makes it possible to appropriately switch to the dual mode DM or the single mode SM.

### 7. Application to Imaging Device

The distance measuring device 1 (1A, 1B, 1C) in the present technology can be applied to an imaging device. For example, the distance measuring device 1B described in the fourth embodiment includes an indirect ToF sensor unit 4 and a color sensor unit 12.

Then, in the second embodiment, the output from the color sensor unit 12 is used to detect the presence or absence of the variation in the angle of view of the color sensor unit 12, but the distance measuring device 1B functions as an imaging device by generating still image data or moving image data on the basis of the output from the color sensor unit 12.

That is, in a case where the distance measuring device 1 is a camera device or a mobile terminal device such as a smartphone having a camera function, an RGB sensor unit or the like provided in advance as a camera function can be used as the color sensor unit 12 without providing a dedicated configuration for detecting movement or a change in posture of the distance measuring device 1, which is preferable.

### 8. Modifications

Note that, in the above-described example, an example has been described in which the distance measuring device 1 includes the inertial measurement device 6, the color sensor unit 12, and the EVS sensor unit 13 in order to detect the movement and posture change of the distance measuring device 1 (1A, 1B, 1C).

However, in a case where the distance measuring device 1 performs processing of changing the angle of view, it is possible to obtain information on the presence or absence of variation in the angle of view without using the output of each sensor unit.

For example, it is considered that the distance measuring device 1 is a monitoring camera, and the monitoring camera can perform an operation of directing an optical axis of the monitoring camera to a place that the user wants to monitor. In this case, since the monitoring camera performs the swing motion to change the angle of view according to the operation from the outside, the distance measuring device 1 can obtain information on whether or not the angle of view has been changed by obtaining information on the swing instruction input from the outside.

In such a case, switching between the dual mode DM and the single mode SM for distance measurement may be performed using instruction information from the outside without using the output from the sensor unit.

### 9. Conclusion

As described in each of the above-described embodiments, the distance measuring device 1 (1A, 1B, 1C) includes: the pixel array unit 4a that performs a light receiving operation for distance measurement in the time-of-flight method (indirect ToF method) using a modulation frequency; the distance measurement processing unit F1 that performs distance measurement of the dual mode DM causing the pixel array unit 4a to alternately perform a light receiving operation using a first frequency (low frequency fL) as the modulation frequency and a row receiving operation using a second frequency (high frequency fH) higher than the first frequency as the modulation frequency and distance measurement of the single mode SM causing the pixel array unit 4a to perform only the light receiving operation using a predetermined frequency as the modulation frequency; and the switching processing unit F2 that switches the distance measurement in the dual mode DM and the distance measurement in the single mode SM (SML, SMH) according to a predetermined condition.

In the distance measurement in the dual mode DM, the irradiation and the light receiving operation of the modulated light intensity-modulated at the first frequency and the irradiation and the light receiving operation of the modulated light intensity-modulated at the second frequency are performed. Therefore, light irradiating and light receiving operations are performed twice in order to obtain distance measurement data once. The distance measurement in the dual mode DM can achieve both high distance measurement accuracy and long distance measurement.

In addition, in the distance measurement in the single mode SM, irradiation of modulated light intensity-modulated at a predetermined frequency and a light receiving operation are performed. Therefore, light irradiation and light receiving operations for obtaining distance measurement information only need to be performed once. In the distance measurement in the single mode SM, power consumption necessary for obtaining one time of distance measurement information is reduced, and a time required for obtaining one time of distance measurement information can be also shortened.

As a result, it is possible to selectively use whether to perform the distance measurement in the dual mode DM in which both the distance measurement accuracy and the distance measurement distance are achieved according to the situation or to perform the distance measurement in the single mode SM in consideration of the power consumption.

As described in the system configuration, the distance measuring device 1 (1A, 1B, 1C) may include the sensor unit (inertial measurement device 6, color sensor unit 12, or EVS sensor unit 13) that performs sensing, and the predetermined condition may be based on information obtained from the sensor unit.

For example, it is conceivable to determine that highly accurate distance measurement by the dual mode DM is necessary in a case where the sensor unit detects that an environment change occurs in which the distance measurement result of the object OB greatly fluctuates. As a result, it is possible to properly use the single mode SM and the dual mode DM.

As described in the system configuration, the distance measuring device 1 (1A) may include the inertial measurement device 6 as the sensor unit, and the predetermined condition may be a condition based on the output of the inertial measurement device 6.

With the provision of the inertial measurement device 6 in addition to the indirect ToF sensor unit 4, it is possible to detect a posture change of a camera device, a mobile terminal device, or the like on which both sensors are mounted. Then, in a case where the posture change is large, it is determined that the distance measurement result for the object OB needs to be measured again with high accuracy, and it is possible to switch to the distance measurement in the dual mode DM.

As a result, it is possible to switch to the dual mode DM capable of performing high-accuracy and long-distance measurement as necessary while obtaining the power consumption reduction effect by using the single mode SM.

As described with reference to FIG. 9 and the like, the switching processing unit F2 of the distance measuring device 1 (1A) may switch to the distance measurement in the dual mode DM in a case where the output of the inertial measurement device 6 is equal to or greater than the threshold, and may switch to the distance measurement in the single mode SM in a case where the output of the inertial measurement device 6 is less than the threshold.

In a case where it is determined that the change in the output of the inertial measurement device 6 is equal to or greater than the threshold and the posture change of the camera device or the mobile terminal device is equal to or greater than a certain level, it is possible to switch to distance measurement in the dual mode DM. As a result, an appropriate distance measurement mode can be selected according to the situation.

As described in the fourth embodiment with reference to FIGS. 15, 16, and the like, the distance measuring device 1B may include the color sensor unit 12 that generates a color image as the sensor unit, the predetermined condition may be a condition related to the view angle variation of the color sensor unit 12 detected on the basis of the output from the color sensor unit 12, and the switching processing unit F2 may switch to the distance measurement in the dual mode DM in a case of determining that there is the view angle variation of the color sensor unit 12, and switch to the distance measurement in the single mode SM in a case of determining that there is no view angle variation.

With the provision of the color sensor unit 12 as an RGB sensor unit or a CMY sensor unit in addition to the indirect ToF sensor unit 4, it is possible to detect a change in the angle of view of a camera device, a mobile terminal device or the like on which both sensors are mounted. In particular, in a case where many of the feature points within the angle of view fluctuate in the same direction, it can be determined that a posture change of the device has occurred, and it is possible to suitably switch to the dual mode DM.

As described in the fifth embodiment with reference to FIG. 17 and the like, the distance measuring device 1C may include the event-based vision sensor unit (EVS sensor unit 13) as the sensor unit, the predetermined condition may be a condition related to the view angle variation of the EVS sensor unit 13 detected on the basis of the output from the EVS sensor unit 13, and the switching processing unit F2 may switch to the distance measurement of the dual mode DM in a case where it is determined that there is the view angle variation of the EVS sensor unit 13, and switch to the distance measurement of the single mode SM in a case where it is determined that there is no view angle variation.

With the provision of the EVS sensor 13 unit in addition to the indirect ToF sensor unit 4, it is possible to detect a change in the angle of view of a camera device, a mobile terminal device, or the like on which both the sensors are mounted. This makes it possible to estimate that a posture change of the device has occurred, and makes it possible to appropriately switch to the dual mode DM.

As described in the second embodiment with reference to FIGS. 11 and 12, and the like, in the distance measuring device 1 (1A, 1B, 1C), the predetermined frequency may be the first frequency (low frequency fL).

That is, a low-frequency signal is used in the light receiving operation of the single mode SM (single mode SML). This is suitable, for example, in a case of use in which it is determined whether or not there is a variation in the object OB within the angle of view while maintaining a state in which long-distance distance measurement is possible.

As described in the second embodiment with reference to FIGS. 11 and 12, and the like, in the distance measuring device 1 (1A, 1B, 1C), the predetermined frequency may be the second frequency (high frequency fH).

That is, a high-frequency signal is used in the light receiving operation of the single mode SM (single mode SMH). This is suitable for maintaining the accuracy of the distance information about the object OB, for example, for tracking the object OB.

As described in the second embodiment with reference to FIGS. 11, 12, and the like, the distance measuring device 1 (1A, 1B, 1C) may include the selection processing unit (switching processing unit F2) that selects one of the first frequency (low frequency fL) and the second frequency (high frequency fH) as the predetermined frequency.

As a result, the frequency of the signal used for the light receiving operation of the single mode SM can be selected according to the situation. In addition, since a desired frequency can be selected from options (Low frequency fL, high frequency fH) prepared in advance, it is not necessary to provide a configuration for calculating the frequency.

As described in the third embodiment with reference to FIGS. 13, 14, and the like, the distance measuring device 1 (1A, 1B, 1C) may include the frequency determination processing unit F3 that determines the predetermined frequency on the basis of the longest distance calculated in the distance measurement processing by the distance measurement processing unit F1.

As a result, it is possible to increase the accuracy of distance measurement while securing a necessary distance measurement distance.

As described in the third embodiment with reference to FIG. 15 and the like, the distance measuring device 1 (1A, 1B, 1C) may include the light emitting unit 2 used for distance measurement of the time-of-flight method (indirect ToF method) and the light emission drive unit 3 that drives the light emitting unit 2 on the basis of a modulation frequency, and the light emission drive unit 3 may determine the number of times of light emission of the light emitting unit 2 in one distance measurement processing on the basis of the predetermined frequency.

For example, in order to perform distance measurement with a certain degree of high accuracy, it is necessary to increase the number of times of light emission as distance measurement is performed over a long distance. Therefore, the number of times of light emission is determined according to the measurable maximum distance so that excessive light emission does not need to be performed, and power consumption can be reduced.

A sensor device as the indirect ToF sensor unit 4 includes: a pixel array unit 4a in which light receiving elements PD that perform a unit light receiving operation in time-of-flight (indirect ToF) distance measurement are two-dimensionally arrayed; and a drive unit that performs, as driving of the pixel array unit 4a, driving in a dual mode DM in which the light receiving elements PD alternately perform a unit light receiving operation with a first frequency (low frequency fL) and a unit light receiving operation with a second frequency (high frequency fH) different from the first frequency, and driving in a single mode SM in which the light receiving elements PD perform only a unit light receiving operation with a predetermined frequency.

In such a sensor device, the above-described various effects can be obtained.

Note that, the effects described in the present specification are merely examples and are not limited, and other effects may be provided.

Furthermore, the above-described respective examples may be combined in any way, and the above-described various functions and effects may be obtained even in a case where various combinations are used.

### 10. Present Technology

(1)

A distance measuring device, including:
a pixel array unit that performs a light receiving operation for time-of-flight distance measurement using a modulation frequency;
a distance measurement processing unit that performs dual mode distance measurement that causes the pixel array unit to alternately perform a light receiving operation using a first frequency as the modulation frequency and a row receiving operation using a second frequency having a higher frequency than the first frequency as the modulation frequency, and single mode distance measurement that causes the pixel array unit to perform only a light receiving operation using a predetermined frequency as the modulation frequency; and
a switching processing unit that switches the distance measurement in the dual mode and the distance measurement in the single mode according to a predetermined condition.
   (2)

The distance measuring device according to the above (1), further including
a sensor unit that performs sensing, in which
the predetermined condition is based on information obtained from the sensor unit.
   (3)

The distance measuring device according to the above (2), in which
the sensor unit includes an inertial measurement device, and
the predetermined condition is a condition based on an output of the inertial measurement device.
(4)

The distance measuring device according to the above (3), in which
the switching processing unit switches to the dual mode distance measurement in a case where an output of the inertial measurement device is equal to or greater than a threshold, and switches to the single mode distance measurement in a case where the output of the inertial measurement device is less than the threshold.
   (5)

The distance measuring device according to the above (2), in which
the sensor unit includes a color sensor unit that generates a color image,
the predetermined condition is a condition related to a view angle variation of the color sensor detected on the basis of an output from the color sensor, and
the switching processing unit switches to the dual mode distance measurement in a case where it is determined that there is the view angle variation, and switches to the single mode distance measurement in a case where it is determined that there is no view angle variation.
   (6)

The distance measuring device according to the above (2), in which
the sensor unit includes an event-based vision sensor unit,
the predetermined condition is a condition related to a view angle variation of the event-based vision sensor detected on the basis of an output from the event-based vision sensor, and
the switching processing unit switches to the dual mode distance measurement in a case where it is determined that there is the view angle variation, and switches to the single mode distance measurement in a case where it is determined that there is no view angle variation.
   (7)

The distance measuring device according to any one of the above (1) to the above (6), in which
the predetermined frequency is the first frequency.
   (8)

The distance measuring device according to any one of the above (1) to the above (6), in which
the predetermined frequency is the second frequency.
   (9)

The distance measuring device according to any one of the above (1) to the above (8), further including
a selection processing unit that selects one of the first frequency and the second frequency as the predetermined frequency.
   (10)

The distance measuring device according to any one of the above (1) to the above (6), further including
a frequency determination processing unit that determines the predetermined frequency on the basis of a longest distance calculated in the distance measurement processing by the distance measurement processing unit.
   (11)

The distance measuring device according to the above (10), further including:
a light emitting unit used for time-of-flight distance measurement; and
a light emission drive unit that drives the light emitting unit on the basis of the modulation frequency, in which
the light emission drive unit determines the number of times of light emission of the light emitting unit in one distance measurement processing on the basis of the predetermined frequency.
   (12)

A sensor device, including:
a pixel array unit in which light receiving elements that perform a unit light receiving operation in time-of-flight distance measurement are two-dimensionally arrayed; and
a drive unit that performs, as driving of the pixel array unit, driving in a dual mode in which the light receiving element alternately performs the unit light receiving operation at a first frequency and the unit light receiving operation at a second frequency different from the first frequency, and driving in a single mode in which the light receiving element performs only the unit light receiving operation at a predetermined frequency.

### REFERENCE SIGNS LIST

1, 1A, 1B, 1C Distance measuring device
2 Light emitting unit
3 light emission drive unit
4 indirect ToF sensor unit (drive unit)
4a Pixel array unit
6 Inertial measurement device (sensor unit)
12 Color sensor unit (sensor unit)
13 EVS sensor unit (sensor unit)
PD Light receiving element
fL Low frequency (first frequency)
fH High frequency (second frequency)
DM Dual mode
SM, SML, SMH Single mode
F1 Distance measurement processing unit
F2 Switching processing unit
F3 Frequency determination processing unit

1. A distance measuring device, comprising:
a pixel array unit that performs a light receiving operation for time-of-flight distance measurement using a modulation frequency;
a distance measurement processing unit that performs dual mode distance measurement that causes the pixel array unit to alternately perform a light receiving operation using a first frequency as the modulation frequency and a row receiving operation using a second frequency having a higher frequency than the first frequency as the modulation frequency, and single mode distance measurement that causes the pixel array unit to perform only a light receiving operation using a predetermined frequency as the modulation frequency; and
a switching processing unit that switches the distance measurement in the dual mode and the distance measurement in the single mode according to a predetermined condition.

2. The distance measuring device according to claim 1, further comprising
a sensor unit that performs sensing, wherein
the predetermined condition is based on information obtained from the sensor unit.

3. The distance measuring device according to claim 2, wherein
the sensor unit includes an inertial measurement device, and
the predetermined condition is a condition based on an output of the inertial measurement device.

4. The distance measuring device according to claim 3, wherein
the switching processing unit switches to the dual mode distance measurement in a case where an output of the inertial measurement device is equal to or greater than a threshold, and switches to the single mode distance measurement in a case where the output of the inertial measurement device is less than the threshold.

5. The distance measuring device according to claim 2, wherein
the sensor unit includes a color sensor unit that generates a color image,
the predetermined condition is a condition related to a view angle variation of the color sensor detected on a basis of an output from the color sensor, and
the switching processing unit switches to the dual mode distance measurement in a case where it is determined that there is the view angle variation, and switches to the single mode distance measurement in a case where it is determined that there is no view angle variation.

6. The distance measuring device according to claim 2, wherein
the sensor unit includes an event-based vision sensor unit,
the predetermined condition is a condition related to a view angle variation of the event-based vision sensor detected on a basis of an output from the event-based vision sensor, and
the switching processing unit switches to the dual mode distance measurement in a case where it is determined that there is the view angle variation, and switches to the single mode distance measurement in a case where it is determined that there is no view angle variation.

7. The distance measuring device according to claim 1, wherein
the predetermined frequency is the first frequency.

8. The distance measuring device according to claim 1, wherein
the predetermined frequency is the second frequency.

9. The distance measuring device according to claim 1, further comprising
a selection processing unit that selects one of the first frequency and the second frequency as the predetermined frequency.

10. The distance measuring device according to claim 1, further comprising
a frequency determination processing unit that determines the predetermined frequency on a basis of a longest distance calculated in the distance measurement processing by the distance measurement processing unit.

11. The distance measuring device according to claim 10, further comprising:
a light emitting unit used for time-of-flight distance measurement; and
a light emission drive unit that drives the light emitting unit on a basis of the modulation frequency, wherein
the light emission drive unit determines the number of times of light emission of the light emitting unit in one distance measurement processing on a basis of the predetermined frequency.

12. A sensor device, comprising:
a pixel array unit in which light receiving elements that perform a unit light receiving operation in time-of-flight distance measurement are two-dimensionally arrayed; and
a drive unit that performs, as driving of the pixel array unit, driving in a dual mode in which the light receiving element alternately performs the unit light receiving operation at a first frequency and the unit light receiving operation at a second frequency different from the first frequency, and driving in a single mode in which the light receiving element performs only the unit light receiving operation at a predetermined frequency.
